(19) United States
(12) Patent Application Publication
(10) Pub. No.: US 2006/0027063 A1
(43) Pub. Date: Feb. 9, 2006

(54) Tooling apparatuses and processes for providing precision shapes in medical catheters

(76) Inventors: Jonathan M. Currier, Nashua, NH (US); Arnold Baldwin, Jaffrey, NH (US)

Correspondence Address: BAKER & HOSTETLER LLP, WASHINGTON SQUARE, SUITE 1100, 1050 CONNECTICUT AVE. N.W., WASHINGTON, DC, 20036-5304, US

(21) Appl. No.: 10/915,014

(22) Filed: Aug. 9, 2004

(51) Int. Cl. B26D 1/00

(52) U.S. Cl. 83/13; 264/138

(57) ABSTRACT

Systems and methods for providing a precision-notch shape in a flexible medical catheter are disclosed. The system comprises a clamp punch die assembly, a clamping device, and a knife-edge punch die. A catheter blank can be inserted in a clamp die about a die pin. The clamping device forces together upper and lower portions of the clamp die, which causes the clamp die to restrain the catheter blank against the die pin. Once the catheter blank is restrained, a punch die with one or more finely-honed blades passes through a notched region in the clamp die and a notched area in the die pin without contacting either to provide the precision-notched portion in the catheter blank. The restraint provided by the clamp die minimizes rotation of the catheter blank, which prevents tearing and excess flashing.

### BACKGROUND OF THE INVENTION

1. Field of the Invention

The present invention relates to apparatuses and processes for providing high-throughput precision shapes in medical catheters and more specifically to novel tooling punch and die devices having knife-edge punch dies for punching precisions shapes in medical catheters and processes using the same.

2. Background Art

Medical tubes, such as catheters, are used extensively in a myriad of medical and surgical applications, e.g., to introduce an object into a patient and/or to remove an object from a patient. In a specific application relevant to this invention, medical catheters are used frequently in performing biopsies in which a sample, e.g., of human tissue, is surgically removed for further testing without invasive surgery. Typically, a small, local incision can be made in the patient through which the distal end of a catheter can be introduced. An optical device can be inserted into the annulus of the catheter to guide the catheter to the required location. Then, with the optical device removed, a sampling device can be inserted into the annulus of the catheter through the proximal end of the catheter to collect the sample.

In some instances, conditions warrant more than one sample. Hence, when multiple samples are needed and taken from multiple locations, another device can be inserted into the annulus of the catheter for the purpose of inserting an easily identifiable marker at the location of each sample to differentiate between sample locations more easily.

Conventionally, medical catheters are manufactured from a sanitized, flexible plastic, e.g., nylon, thermoplastic polyurethane (TPU), and the like, of varying lengths. Such materials will have a suitable Shore A or Shore D hardness which will reduce the possibility of any damage associated with the catheter's entry and ultimate application. For example, preferred plastics have a Shore D value between about 0-100 durometer, more preferably between about 40-80 durometer.

Essentially, medical catheters are tubes having a distal end, which is insertable into a patient, a proximal end, which remains outside of the patient and through which medical personnel can introduce and remove various medical devices, and an annulus that provides communication between the distal and proximal ends of the catheter. Although the proximal end is generally open, the distal end can be opened or closed. When closed, typically, one or more openings are provided in the perimeter walls in proximity of the distal end of the catheter.

A typical catheter has an outer diameter less than about 0.118 inches (3 mm) and a wall thickness less than about 0.02 in. (½ mm). The dimensions and flexible composition of such a catheter, however, make it difficult to fashion some openings in a manner that is not labor-intensive and that, further, provides high throughput. This is particularly true in the manufacture of medical catheters such as those used for taking breast biopsies. A representative example of such a medical catheter is shown in FIGS. 1A through 1C.

FIGS. 1A and 1B show, respectively, a plan view and a side elevation view of a flared tube assembly (hereinafter, catheter 10) currently being used for such biopsies. The catheter 10 is about 8.7 inches (about 22 mm) in length and the tubing has an outer diameter 19 of about 0.099 inches (about 2.5 mm). The catheter 10 includes a closed, distal end 12 and an open, proximal end 14. At its proximal end 14, the catheter 10, further, can include a flared portion 16 that can be used for securing the catheter 10 in a separate, surgical assembly (not shown). The distal end 12 of the catheter 10 includes a precision-notched portion 18, which is shown in greater detail in FIG. 1C and discussed further below.

The precision-notched portion 18 at the distal end 12 of the catheter 10 has a length 15 of about 0.5 inches (about 12.7 mm) and a depth of about 0.04 inches (about 1 mm). Preferably, the front portion 11 of the notched portion 18 is oriented at approximately 50 degrees and the back portion 13 of the notched portion is oriented at approximately 90 degrees.

Referring to FIG. 2, a currently practiced method of manufacturing the precision-notched portion 18 of the catheter 10 will be described. FIG. 2 shows an illustrative example of a catheter 10 disposed in a steel template 20. The steel template 20 includes a notched region 25 that conforms to the above-described specification, which is to say that, the notched region 25 will provide a precision-notched portion 18 at the distal end 12 of the catheter 10 that is about 0.5 inches (about 12.7 mm) long and about 0.04 inches (about 1 mm) deep. Furthermore, the notched region 25 will provide a front portion 11 of the notched portion 18 that is oriented at approximately 50 degrees and a back portion 13 of the notched portion that is oriented at approximately 90 degrees.

With such a conventional device, the catheter 10 is placed in the steel template 20 and the notched portion 18 is scraped out manually, e.g., using a very sharp knifing tool, skiving tool, scalpel or the like. The scraping process, however, suffers from several shortcomings. First, it is a labor-intensive process that does not lend itself to high throughput. Second, the knifing tool, skiving tool, scalpel or the like dulls quickly and must be changed out regularly, e.g., sharpened or replaced on a frequent basis. Indeed, a typical blade is suitable for scraping only two or three notched portions 18 before a change of blades is necessary. Third, the cutting blade is dangerous and can lead to injury as blades dull and laborers tire from their work.

To date, attempts to provide a precision-notched portion 18 in a medical catheter 10 mechanically have failed. More specifically, to date, attempts to provide a precision-notched portion 18 at the distal end 12 of a catheter 10 using a punch and die system have not been successful. There are several reasons for past failure.

First, punching is most easily and successfully performed when the punching tool is disposed and the punching step is performed perpendicular or substantially perpendicular to the item to be punched. However, for the intended biopsy use, the precision-notched portion 18 of the medical catheter 10 is substantially oval shaped, further, requiring a precise 50-degree cut at the front portion 11 and a 90-degree cut at the back portion 13. As a result, this necessitates punching the catheter blank 10 from the side; this position is problematic in that it is difficult to achieve efficient punching.

Second, punching works more efficiently when punching rigid or elastic, i.e., non-plastic, materials, e.g., metals and metal alloys, that are little affected by temperature and humidity changes and, moreover, that cut cleanly. In contrast, in most instances, most plastics rip or tear when punched. Rotation occurs because, before the punching tool has a chance to remove the precision-notched shape completely, the force of the punching tool applied to the catheter blank causes the plastic to rotate in the notched region 25 of the die 20. Furthermore, temperature changes can aggravate tearing. Indeed, tearing of punched plastics is more pronounced at higher temperatures when the plastic is softer and more prone to rotation. Tearing also becomes more pronounced as the punching tool dulls.

Another notable disadvantage associated with tearing is that it produces “flashing”. Flashing is a term used in the art to describe roughened and/or jagged edging. In a typical process, loose and hanging flashing must be further removed, typically by hand, adding further expense to the overall operation. This problem illustrates yet another shortcoming of conventional tools and processes and accentuates the prior art's inability to provide (and thus, the need for) a mechanical punching means for providing a notched portion 18 in a medical catheter 10.

Therefore, it would be desirable to provide devices, systems, and processes for providing a precision opening 18 in the distal end 12 of a medical catheter 10 mechanically and with high throughput. It would also be desirable to provide a device and method for providing a precision opening 18 in the distal end 12 of a medical catheter 10 with minimal flashing that can be rapidly removed.

### BRIEF SUMMARY OF THE INVENTION

In a first embodiment, the present invention includes a clamp punch die assembly for retaining a catheter blank during a punching operation to provide a precision-notched portion in the catheter blank using a knife-edge punch die. According to one aspect of the first embodiment of the present invention, the assembly comprises a clamp die having an upper portion, a lower portion, a machined portion, and a die pin annulus; and a die pin that is removably and securely disposed in the die pin annulus and about which the catheter blank can be installed; wherein a clamping force can be applied to at least one of the upper and lower portions of the clamp die to force together the upper and lower portions of the clamp die through the machined portion so that the die pin annulus encompasses the catheter blank and forces the catheter blank against the die pin to minimize rotation of the catheter blank during the punching operation.

In another aspect of the first embodiment of the present invention, the clamp die includes a notched region and the die pin includes a notched area through which the knife-edge punch die can traverse to remove the precision-notched portion of the catheter blank. Preferably, the notched region and notched area are in registration with each other so that, during removal of the precision-notched portion of the catheter blank, the knife-edge punch die does not contact the clamp die or the die pin. More preferably, the notched region and notched area are structured and arranged so that the precision-notched portion of the catheter blank includes an approximately 90-degree angle at one end of the precision-notched portion and an approximately 50-degree angle at another end of the precision-notched portion.

In another aspect of the first embodiment of the present invention, the machined portion is a discontinuous opening that bisects the clamp die into its upper and lower portions.

In a second embodiment, the present invention discloses a system for providing a precision-notched shape on a catheter blank. The system comprises a clamp punch die assembly for retaining a catheter blank during a punching operation; a clamping means to force together the upper and lower portions of the clamp die; and a knife-edge punch die to remove the precision-notched area from the catheter blank. In a preferred embodiment, the clamp punch die assembly includes a clamp die and a die pin that is structured and arranged concentrically and coaxially with the die pin annulus and about which the catheter blank can be installed.

In one aspect of the second embodiment of the present invention, the clamping means comprises a circular clamping means that, when engaged, provides approximately 360-degree restraint against movement or rotation of the catheter blank during a punching operation.

In another aspect of the second embodiment of the present invention, the clamp die includes a notched region and the die pin includes a notched area through which the knife-edge punch die can traverse to remove the precision-notched portion of the catheter blank. Moreover, the notched region and notched area are structured and arranged so that, during removal of the precision-notched portion of the catheter blank, the knife-edge punch die does not contact the clamp die and/or die pin.

In yet another aspect of the second embodiment of the present invention, the notched region and the notched area are structured and arranged so that precision-notched portion of the catheter blank includes an approximately 90-degree angle at one end of the precision-notched portion and an approximately 50-degree angle at another end of the precision-notched portion.

In a third embodiment, the present invention discloses a method of providing a precision-notched portion in a catheter blank, the method comprising the steps of:

providing a clamp punch die assembly and a die punch assembly;

removably and securely attaching a distal end of the clamp punch die assembly in the die punch assembly;

removably and securely inserting a proximal end of the clamp punch die assembly in a clamp die rest assembly;

inserting the catheter blank in a die pin annulus about the die pin;

clamping the clamp die pin so that the periphery of the die pin annulus forces the catheter blank against said die pin to minimize rotation of the catheter blank; and

punching the precision-notched portion in the catheter blank using a punching tool.

In one aspect of the third embodiment, the step of clamping the clamp die assembly includes applying a clamping force to at least one of the upper and lower portions of the clamp die to force together the upper and lower portions of the clamp die assembly through the machined portion so that the die pin annulus encompasses the catheter blank and forces the catheter blank against the die pin, to minimize rotation of the catheter blank during the punching step. In another aspect of the third embodiment, the step of punching the precision-notched portion of the catheter blank includes forming an approximately 90-degree angle at one end of the precision-notched portion and forming an approximately 50-degree angle at another end of said precision-notched portion. In yet another aspect of the third embodiment, the present invention includes one or more of the steps of removing any flashing produced during the punching step; heat-flashing the precision-notched portion of the catheter blank to smooth the periphery of the precision-notched portion; and tipping the distal end of the catheter blank.

### BRIEF DESCRIPTION OF THE DRAWINGS

The invention will be better understood by reference to the following more detailed description and accompanying drawings:

FIG. 1A is a plan view of a medical catheter specified for use in some surgical biopsies;

FIG. 1B is a side elevation view of a medical catheter specified for use in some surgical biopsies;

FIG. 1C is a section view of the precision-notched portion of the distal end of a medical catheter specified for use in some surgical biopsies;

FIG. 2 is an illustrative example of a steel template used in the prior art to manually scrape out a notched portion in the distal end of a medical catheter;

FIG. 3 is an isometric view of an illustrative embodiment of a circular punch and die system in accordance with the present invention;

FIG. 4 is an isometric view of an illustrative embodiment of a punch press device in accordance with the present invention;

FIG. 5A is an isometric view of an illustrative embodiment of a two-piece knife-edge punch in accordance with the present invention;

FIG. 5B is an isometric view of an illustrative embodiment of a one-piece knife-edge punch in accordance with the present invention;

FIG. 6A is an isometric view of an illustrative embodiment of a circular clamp die assembly in accordance with the present invention;

FIG. 6B is a plan view of an illustrative embodiment of a die pin/mandrel in accordance with the present invention;

FIG. 6C is a side elevation view of an illustrative embodiment of a die pin/mandrel in accordance with the present invention;

FIG. 6D is a side, cross-sectional view of an illustrative embodiment of a circular clamp die in accordance with the present invention;

FIG. 7 is a side elevation of an illustrative embodiment of a clamping means in accordance with the present invention;

FIG. 8 is a flow chart of a preferred method of preparing medical catheters with a precision-notched portion;

FIG. 9 is a diagrammatic view of an illustrative embodiment of a heat-flash device in accordance with the present invention;

FIG. 10 is a diagrammatic view of an illustrative embodiment of the heating and masking trays of the heat-flash device in accordance with the present invention; and

FIG. 11 is an isometric view of an illustrative, alternative embodiment of a circular clamp die in accordance with the present invention.

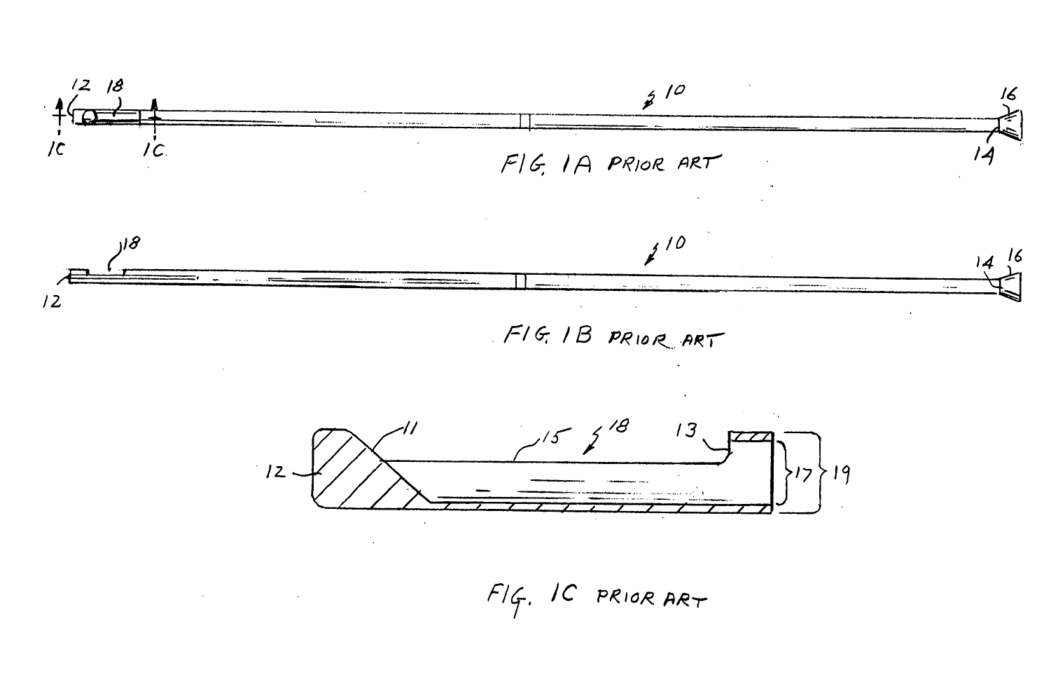

### DETAILED DESCRIPTION OF THE INVENTION AND PREFERRED EMBODIMENTS THEREOF

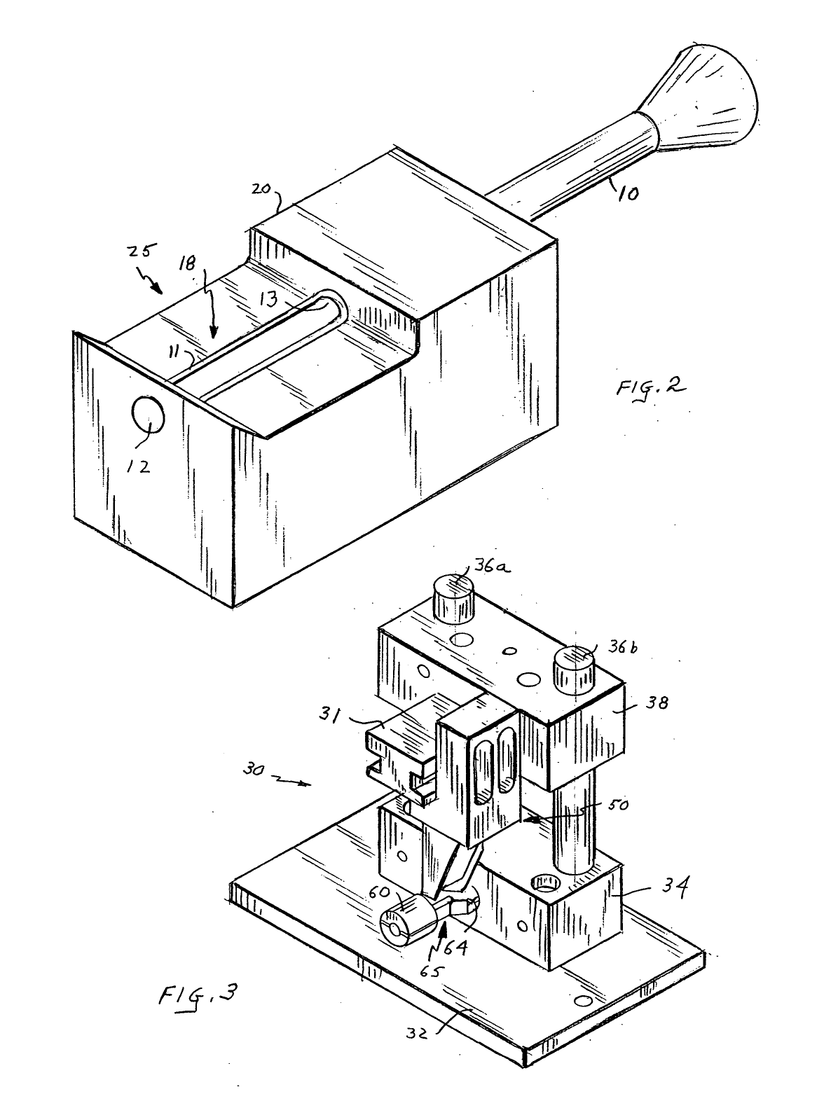

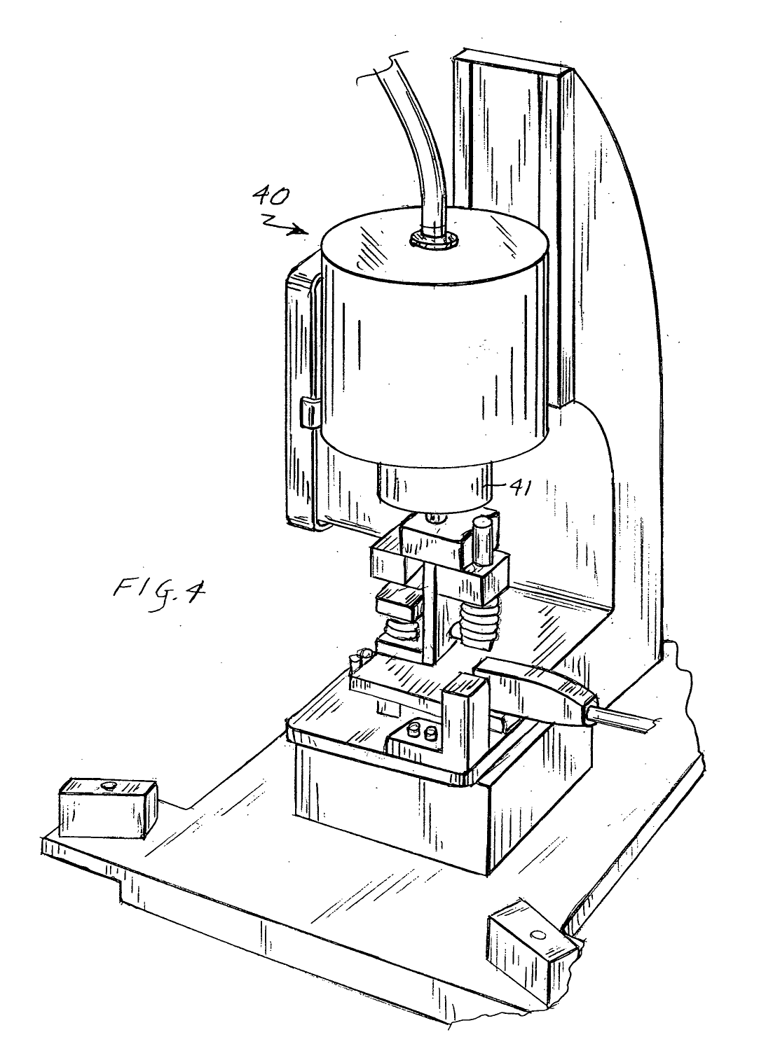

A front, isometric view of an illustrative embodiment of a circular punch and die system 30 according to the present invention is shown in FIG. 3. Referring to FIG. 3, the embodied system 30 comprises a circular clamp die assembly 60 in combination with a knife-edge punch die 50, each of which will be described in greater detail below. The embodied system 30 further includes a clamp base 32 for securely and releasably attaching the system 30 to a fixed structure to restrain movement of the system 30 during punching operations.

A die bottom 34 is securely and releasably attached to the clamp base 32. The die bottom 34 is structured and arranged to hold, or grip, and restrain the distal end 63 of the circular clamp die assembly 60, e.g., providing a tight interference fit. The die bottom 34 further securely supports a pair of guide (die) pins 36a and 36b along which a die top 38 can translate in a vertical or substantially vertical direction. Preferably, the guide pins 36a and 36b are cylindrical.

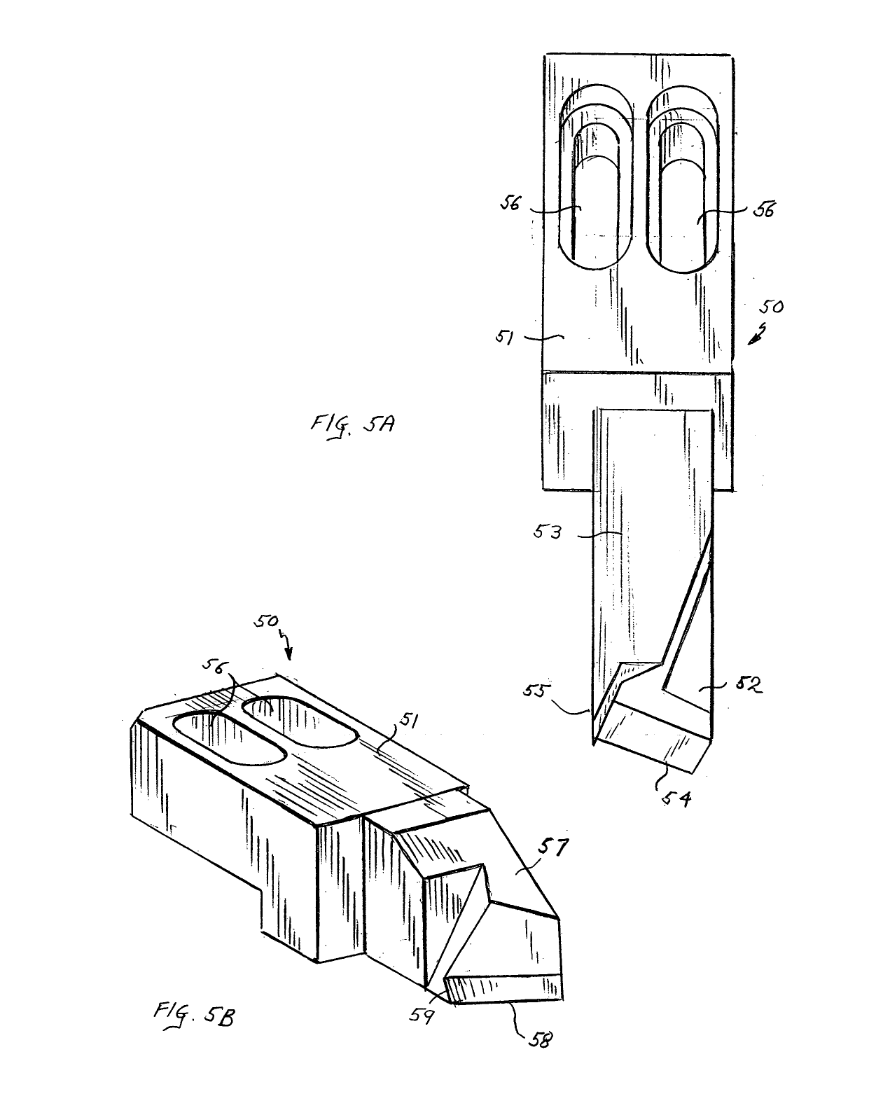

The movable die top 38 translates in a vertical or substantially vertical direction along the guide pins 36a and 36b when acted upon by a punch press 40, which is shown in FIG. 4. Preferably, a knife-edge punch die 50 having a removable, knife-edge blade portion is securely and removably attached to a die key 31, which, itself, is securely and removably attached to the die top 38. The die top 38, die key 31, and punch die 50 are structured and arranged so that when the cylinder 41 of the punch press 40 forces the die top 38 downward, the knife-edge punch die 50 is forced to translate through the notched region 65 of the circular clamp die assembly 60, punching out the precision-notched portion 18 of the catheter blank 10 swiftly and cleanly.

Preferably, a stroke-limiting means (not shown) is provided coaxially on each of the guide rods 36a and 36b or between the guide rods 36a and 36b to limit the extent of the stroke of the punching action. Some examples of stroke-limiting means can include high-tension springs, ball bushings, damping pots, hydraulic cylinders, and the like. These stroke-limiting means are not to be understood to be restrictive as other means of limiting the stroke of the punching action are well known to those skilled in the art and are well within the scope and spirit of this disclosure.

Referring to FIGS. 5A and 5B, illustrative embodiments of knife-edge punch dies 50 will be described. FIG. 5A provides an illustrative embodiment of a preferred two-piece, knife-edge punch die 50 and FIG. 5B provides an alternative illustrative embodiment of a one-piece, knife-edge punch die 50.

According to one aspect of the present invention, the two-piece, knife-edge punch die 50 includes a mounting body 51 and two removable knife-edge portions 52 and 53. The mounting body 51 can include a pair of mounting openings 56 for mounting the knife-edge punch die 50 to the die key 31, e.g., using a plurality of bolts or screws. Preferably, the mounting body 51 and knife-edge portions 52 and 53 are made of hardened tool steel and, more preferably, the mounting body 51 and knife-edge portions 52 and 53 are made of hardened tool steel that has a Rockwell C hardness range between about 58 and about 62. The Rockwell C hardness range can be greater than 62 or less than 58, without violating the scope and spirit of this specification, although, at some point the mounting body 51 and knife-edge portions 52 and 53 can become too brittle if the hardness is too large.

The primary knife-edge portion 52 can be securely and removably attached to the mounting body 51 of the punch die 50. A secondary knife-edge portion 53 is securely and removably attached to the primary knife-edge portion 52, e.g., using a plurality of bolts or screws. The primary knife-edge portion 52 includes a finely honed knife-edge blade 54 that is structured and arranged to punch the length 15 and the 50-degree angle portion 11 of the precision-notched portion 18 of the catheter blank 10. The secondary knife-edge portion 53 includes a finely honed knife-edge blade 55 that is structured and arranged to punch the 90-degree angle portion 13 of the precision-notched portion 18 of the catheter blank 10. The knife-edge blades 54 and 55 of the primary and secondary knife-edge portions 52 and 53 are structured and arranged to pass through the notched region 65 of the circular clamp punch die assembly 60 with no or minimal contact between the same.

In another aspect of the present invention, a counterweight (not shown) can be structured and arranged opposite the knife-edge punch die 50 on the die key 31 to retard likely rotation of the knife-edge punch die 50, to prevent the primary and secondary knife-edge blades 54 and 55 from contacting the notched region 65 of the circular clamp punch die assembly 60.

Referring to FIG. 5B, a one-piece, knife-edge punch die 50 will be described. The one-piece, knife-edge punch die 50 includes a mounting body 51 and a single knife-edge portion 57. The mounting body 51 also includes a pair of mounting openings 56 for mounting the knife-edge punch die 50 to the die key 31, e.g., using a plurality of bolts or screws. Preferably, the mounting body 51 and knife-edge portion 57 are made of hardened tool steel and, more preferably, the mounting body 51 and knife-edge portion 57 are made of hardened tool steel that has a Rockwell C hardness range between about 58 and about 62. The Rockwell C hardness range can be greater than 62 or less than 58, without violating the scope and spirit of this specification, although, at some point the mounting body 51 and knife-edge portion 57 can become too brittle if the hardness is too large.

The knife-edge portion 57 can be securely and removably attached to the mounting body 51. The knife-edge portion 57 includes a finely honed knife-edge blade 58 that is structured and arranged to punch the length 15 and the 50-degree angle portion 11 of the precision-notched shape 18 of the catheter blank 10. Because there is no secondary knife-edge portion 53, the 90-degree angle portion 13 of the precision-notched shape 18 of the catheter blank 10 will be formed by the blunt portion 59 of the knife-edge blade 58. This may cause slightly more ripping and tearing of the catheter blank 10 than would be the case with a two-piece punch die 50, requiring removal of slightly more “flashing”.

The knife-edge blade 58 is structured and arranged to pass through the notched region 65 of the circular clamp punch die assembly 60 with no or minimal contact between the same. In another aspect of the present invention, a counterweight (not shown) can be structured and arranged opposite the knife-edge punch die 50 on the die key 31 to retard likely rotation of the knife-edge punch die 50, to prevent the knife-edge blade 58 from contacting the notched region 65 of the circular clamp punch die assembly 60.

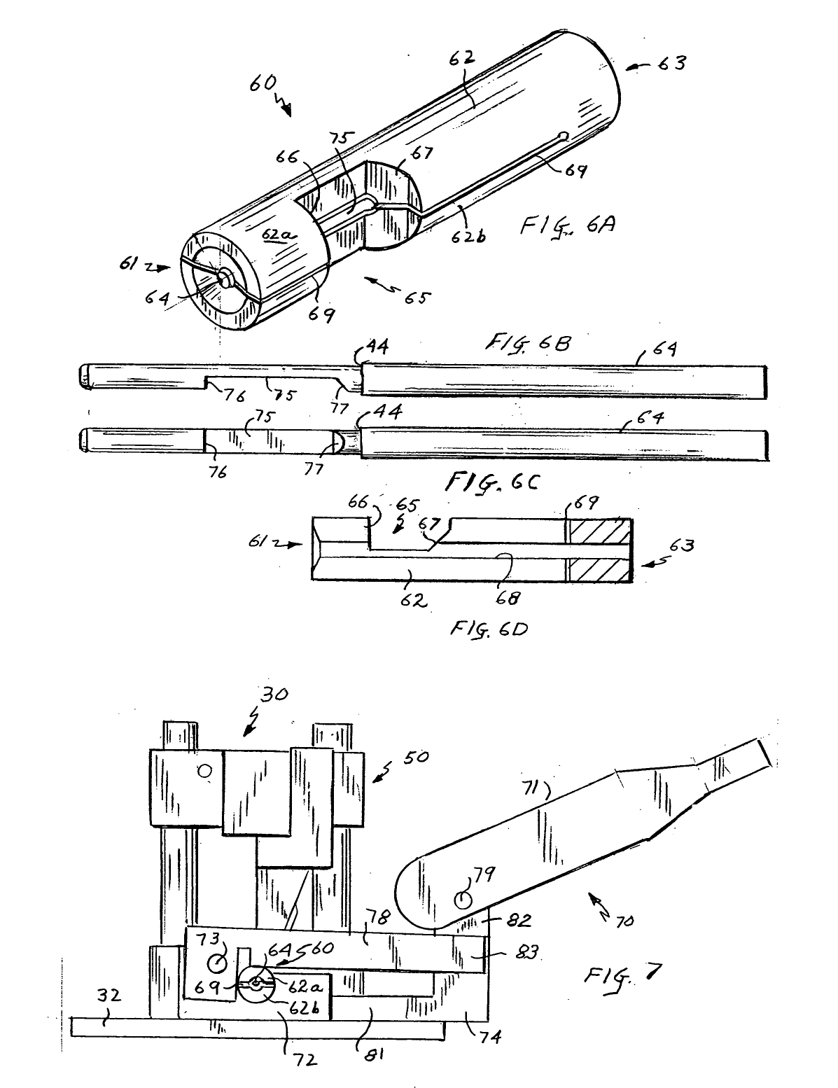

Referring now to FIGS. 6A through 6D, a preferred embodiment of a circular clamp punch die assembly 60 in accordance with this invention will be described. The purpose of the circular clamp punch die assembly 60 is to arrest rotation and/or movement of the catheter blank 10 during the punching operation. To this end, a circular clamp that firmly clamps a substantial length of either side of the precision-notched portion 18 of the catheter blank 10 and that, further, clamps the entire periphery, or a substantial portion of the periphery, of the substantial length of either side of the precision-notched portion 18 of catheter blank 10 is preferred.

In a preferred embodiment, the circular clamp punch die assembly 60 comprises a circular clamp die 62 and a die pin, or mandrel, 64. The die pin/mandrel 64 is a cylindrical, stainless steel die pin having a diameter that is slightly less than the inner diameter of the annulus 17 of the catheter blank 10 to allow a catheter blank 10 to pass around it effortlessly. Although any metal or metal alloy with a high Young's modulus can be used for the die pin/mandrel 64, stainless steel is preferred. The die pin/mandrel 64 includes a notched area 75 that is a template of the desired precision-notched shape 18 of the catheter blank 10. In a specific embodiment, the notched area 75 is about 0.04 inch (about 1 mm) deep and includes an approximately 90-degree angle at one end 76 and an approximately 50-degree angle at the other end 77.

The die pin/mandrel 64 further includes a stop plug 44, which arrests further insertion of the catheter blank 10 beyond the ground shoulder of the stop plug 44. Prior to the punching step, a catheter blank 10 can be inserted into the die pin annulus 68 at the proximal end 61 of the circular clamp die 62. The catheter blank 10 is inserted about the die pin/mandrel 64 until the ground shoulders of the stop plug 44 arrest any further insertion of the catheter blank 10.

In a preferred embodiment, the circular clamp die 62 is made of stainless steel in a cylindrical shape having a proximal end 61 and a distal end 63. Although any metal or metal alloy with a high Young's modulus can be used for the circular clamp die 62, stainless steel is preferred. The circular clamp die 62 includes a die pin annulus 68 that has been bored out of the center of the circular clamp die 62, extending the entire length, or substantially the entire length, of the circular clamp die 62. In one aspect of the present invention, the die pin annulus 68 has a diameter that is slightly larger than the outer diameter 19 of a catheter blank 10 to allow the catheter blank 10 to pass into the circular clamp die annulus 68 effortlessly.

The circular clamp die 62 includes a discontinuous, machined portion, or slit, 69, which extends from the proximal end 61 to a point near the distal end 63. The machined portion 69 bisects the circular clamp die 62 into an upper portion 62a and a lower portion 62b. Preferably, the machined portion 69 is structured and arranged through the diameter of the circular clamp die 62 and extends about two-third to three-fourths the length of the circular damp die 62. In one aspect of the present invention, the machined portion 69 has been machined by an EDM process.

A notched region 65 is structured and arranged near the proximal end 61 of the circular clamp die 62. At a first end 66, the notched portion 65 includes an approximately 90-degree angle and at a second end 67 the notched region 65 includes an approximately 50-degree angle. Although the first end 66 and second end 67 are described in the specification as having, respectively, a 90-degree angle and a 50-degree angle, the invention is not to be restricted or limited just to precision-notched portions 18 having those angles. Indeed, practically any angle combination at the first end 6 and second end 67 are possible. The notched region 65 of the circular clamp die 62 is further structured and arranged to be in registration with the notched area 75 of the die pin 64 to allow the knife-edge punch die 50 to pass through the notched region 65 and notched area 75 with no or minimal contact with either.

Referring to FIG. 7, an illustrative embodiment of a preferred embodiment of a clamping means 70 will be described. The clamping means 70 comprises a support arm 74, a first lever arm 71, a second lever arm 78, and a circular clamp die rest 72. The circular clamp die rest 72 can be removably and securely attached to the base plate 32 and includes a removed portion into which the circular damp die assembly 60 is inserted prior to clamping and punching. The circular clamp die rest 72, further, includes a pivot pin 73 about which the second lever arm 78 is securely and rotatably mounted.

Preferably, the support arm 74 is L-shaped with the first leg 81 of the support arm 74 securely and removably attached to the base plate 32 and the second leg 82 of the support arm 74 extending upwards, perpendicular, or substantially perpendicular, to the first leg 81 and the base plate 32. The second leg 82 of the support arm 74 includes a pivot pin 79 about which a first lever arm 71 is securely and rotatably mounted.

In operation, the first lever arm 71 can be rotated, e.g., manually, about the pivot pin 79 so that the first lever arm 71 biases the second lever arm 78 at a distal end 83. The force applied to the distal end 83 of the second lever arm 78 causes the second lever arm 78 to rotate about pivot pin 73, further applying force to the circular clamp die 62. The force applied to the circular clamp die 62 is transferred to the upper portion 62a of the circular clamp die 62, causing the upper portion 62a to displace through the machined portion 69 towards the lower portion 62b of the circular clamp die 62. The circular die clamp rest 72, further, restrains the lower portion 62b of the circular damp die 62. As a result, the circular clamp 60 provides circumferential restraint all around, i.e., 360-degree, or substantially all around, the outer periphery of the catheter blank 10 prior to punching. Although a specific embodiment of a clamping means 70 has been described, this has been done for illustrative purposes only. Those skilled in the art can provide a myriad of devices that cause the upper portion 62a of the circular clamp die 62 to displace through the machined portion 69 to provide circumferential restraint of the catheter blank 10, all of which are within the scope and spirit of this invention.

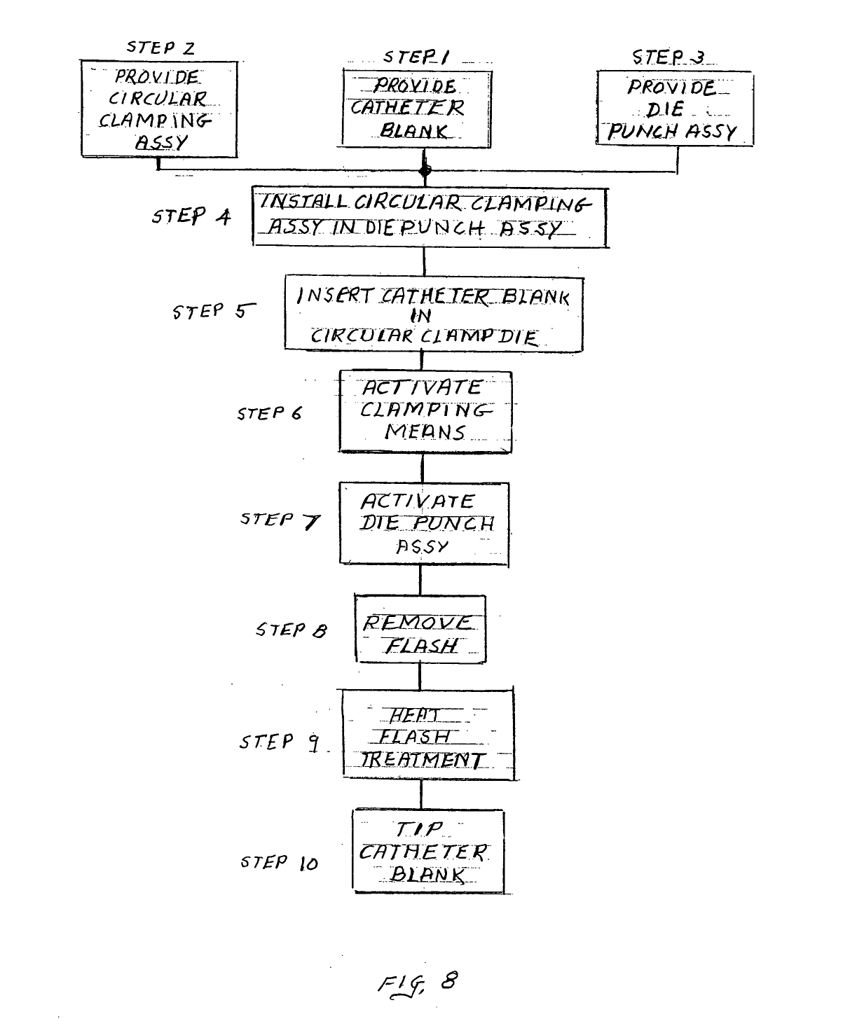

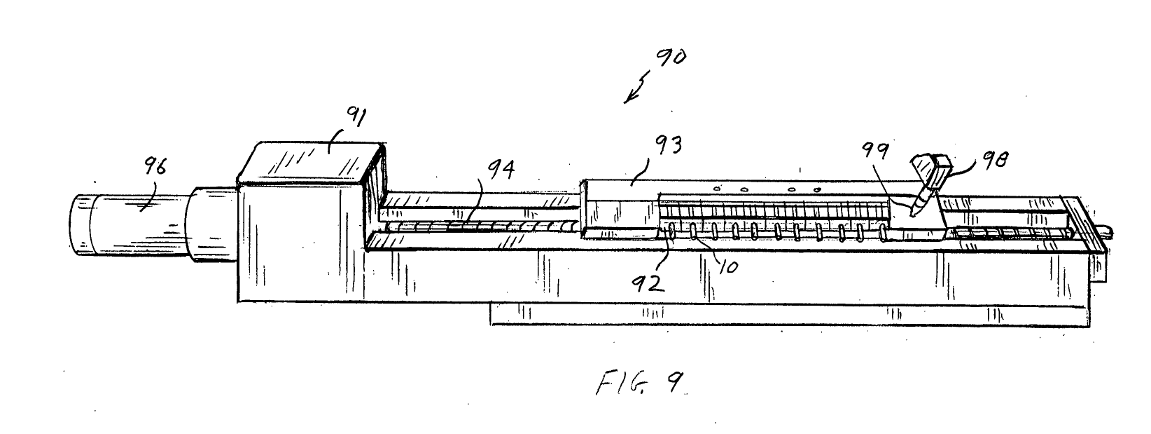

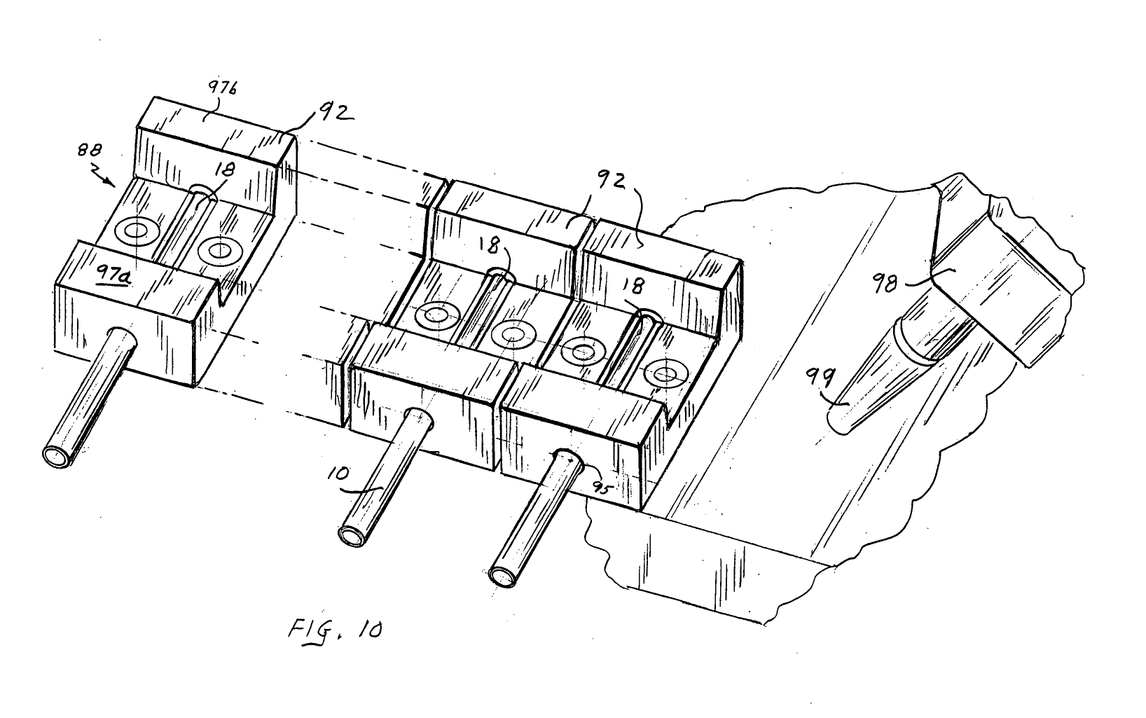

Having described preferred embodiments of a circular clamp die assembly 60 and a circular clamp punch and die system 30, we will now describe a preferred method of providing medical catheters 10 with a precision-notched portion 18. FIG. 8 provides a flow chart of a preferred embodiment of the manufacturing process.

In a first step, a plurality of catheter blanks is provided STEP 1. Preferably, the catheter blanks are made of a relatively firm plastic or thermoplastic having a Shore rating of about 72-D. More preferably, the catheter blanks have an outer diameter of about 0.99 inches (25.4 mm) and an inner diameter of about 0.95 inches (25 mm). Also, necessarily provided are a circular clamp die assembly that includes a circular clamp die and a die pin/mandrel (FIGS. 6A to 6D) STEP 2 and a die punch assembly (FIG. 3) that includes a punch press (FIG. 4) STEP 3. Preferably, the notched region of the circular clamp die and the notched area of the die pin/mandrel are in registration with each other and, further, the notched area and notched region are aligned with the cutting blade(s) of the die punch assembly.

The distal end of the circular clamp die assembly can be removably and securely inserted into a circular opening provided in the die punch assembly for that purpose STEP 4. Furthermore, the proximal end of the circular clamp die can be securely and removably mounted in the circular clamp die rest of the clamping means. Finally, the circular clamp die assembly and die punch assembly can be mounted in the press punch with the cylinder of the press punch in registration with the top portion of the die punch assembly.

A catheter blank can now be inserted in the circular clamp die about the die pin/mandrel STEP 5. As described in greater detail above, the catheter blank bottoms out on the ground shoulder, i.e., stop plug, of the die pin/mandrel.

Once the catheter blank has been inserted in the circular clamp die, the circular clamping means can be activated STEP 6 to provide full peripheral, i.e., 360-degree, or substantially full peripheral, confinement of the catheter blank. The clamping step can be performed manually, e.g., using the double-lever system described in greater detail above. With the catheter blank so restrained, the punch press can now be activated STEP 7 to cause the knife-edge punch to travel through the portion of the catheter blank that is exposed at the notched region of the circular clamp die and the notched area of the die pin/mandrel, providing the desired precision-notched opening near the distal end of the catheter blank. In an alternative embodiment, the punch press itself can be structured and arranged so that the hydraulic action of the cylinder of the punch press provides a clamping force to force together the two portions of the circular clamp die immediately before the actual punching step is performed.

The catheter blank can then be removed from the circular clamp die and inspected for “flashing” along the precision-notched opening, i.e., the punched opening. Normally, flashing, if any, can be removed manually STEP 8, e.g., using a straightedge blade, and, because of the clean manner is which the catheter blank was punched, easily. To provide a neater finish to the precision opening, heat-flashing is provided STEP 9.

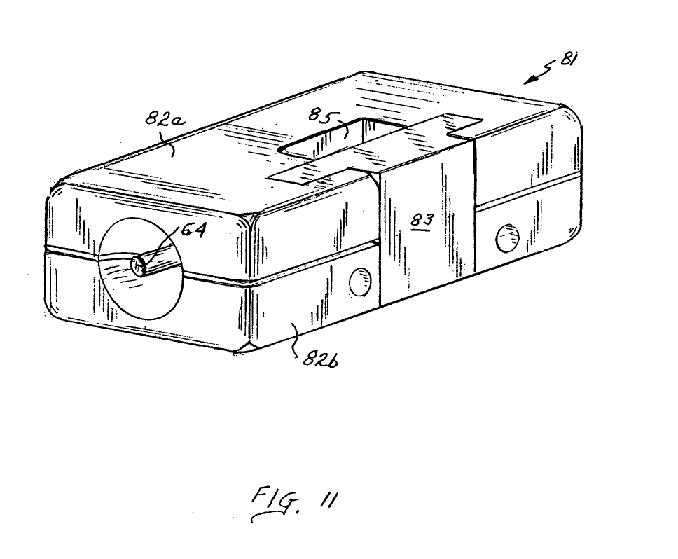

Referring to FIGS. 9 and 10, an illustrative embodiment of a heat-flashing device 90 and the heat-flashing step STEP 9 in accordance with the present invention will be described. Heat-flashing subjects the precision-notched opening 18 of the catheter blank 10 briefly to a burst of hot air from a hot air-nozzle 98 to smooth the periphery of the exposed, punched portion 18 of the catheter blank 10. Preferably, the temperature of the hot air-nozzle 98 is at or slightly above the melting point of the catheter blank material.

For example, typically, for a nylon catheter, the temperature of the hot air should be about 490 degrees Fahrenheit. More preferably, only the punched portion 18 of the catheter blank 10 is subject to the high temperature air blast. The rest of the catheter blank 10 is either thermally masked or sufficiently distant from the end 99 of the hot-air nozzle 98 such that the hot-air blast has no effect.

As seen in the embodied heat-flashing device 90, the device 90 comprises a main body or frame, 91, a motor 96 that is capable of driving a rotatable screw 94, and a tray-holding device 93. The tray-holding device 93 is translatably attached to the screw 94 so that when the motor 96 rotates the screw 94, the rotation of the screw 94 causes the tray-holding device 93 to translate, for example laterally from left to right or from right to left.

A plurality of holding and masking trays 92 are securely and removably attached to a translatable tray-holding device 93. Although FIG. 9 shows eleven holding and masking trays 92, the number of trays shown is only illustrative. As a result, heat-flashing devices 90 with more or fewer trays 92 are within the scope and spirit of this disclosure.

Each tray 92 includes an annulus 95, a pair of masking portions 97a and 97b, and an exposed portion 88. Preferably, the annulus 95 is structured and arranged for the insertion of a catheter blank 10 with a precision-notched region, i.e., punched region 18, as described above. More preferably, the exposed portion 88 and masking portions 97a and 97b of the holding and masking trays 92 are structured and arranged so that only the punched region 18 of the catheter blank 10 is exposed in exposed portion 88 of the tray 92.

Once catheter blanks 10 have been inserted in each of the trays 92, the motor 96 of the heat-flashing device 90 can be activated to rotate the screw 94, causing the translatable tray-holding device 93 to move laterally in the direction of the heating means 98. The heating means 98 provides a short burst of high heat emanating from the end 99 of the hot-air nozzle 98 that is concentrated on the exposed, punched portion 18 of the catheter blank 10 to round-off and smooth the periphery of the punched portion 18 of the catheter blank 10.

Means of providing a quick blast of hot air through a hot-air nozzle 98 are well known to those skilled in the art and need not be discussed in greater detail. Preferably, the motor 96 provides a controllable motor speed so that the catheter blank 10 in each tray 92 is exposed to the end 99 of the hot-air nozzle 98 for a sufficient amount of time to flash heat the punched portion 18 of the catheter blank 10, melting the peripheral area of the punched portion 18. The masking portions 97a and 97b protect the rest of the distal end 12 of the catheter blank 10. The flash-heated, punched portion 18 provides a smoother, higher quality finish to the punched portion 18 of the catheter blank 10 than would otherwise be the case with just the knife-edge punching.

After the catheter blank has been flash-heated, the catheter blank 10 can be “tipped” to close the open end of the distal end 12 of the catheter blank 10 STEP 10. Tipping techniques are well known to the art and will not be discussed further.

Although preferred embodiments of the invention have been described using specific terms, such descriptions are for illustrative purposes only, and it is to be understood that changes and variations may be made without departing from the spirit or scope of the following claims.

For example, although a preferred cylindrical circular clamp die using an external clamping means has been described, in a second embodiment, the circular clamp punch die assembly 81 can include upper and lower portions 82a and 82b and a die pin/mandrel 64 (FIG. 11). A catheter blank 10 can be inserted about the die/pin mandrel 64 and placed between the upper and lower portions 82a and 82b of the clamp die assembly 81. A clamping arm 83 that rotates about a pin (not shown) can be rotated and releasably locked. As the clamping arm 83 rotates, it presses together the upper and lower portions 82a and 82b, providing full, or substantially full peripheral confinement of the catheter blank 10 in proximity of either end of the precision-notched portion 18. The clamp die assembly includes a window 85 through which the knife-edge punch die 50 can translate. A notched region (not shown) in the window 85, the notched area (not shown) of the die pin/mandrel 64, and the punch die 50 can be structured and arranged so that the blade of the knife-edge portion of the punch die 50 can pass through the catheter blank 10 with no or minimal contact with the same.

What is claimed is:

1. A clamp punch die assembly for retaining a catheter blank during a punching operation to provide a precision-notched portion in the catheter blank using a knife-edge punch die, the assembly comprising:
a clamp die having an upper portion, a lower portion, a machined portion, and a die pin annulus; and
a die pin that is removably and securely disposed in the die pin annulus and about which said catheter blank can be installed;
wherein a clamping force can be applied to at least one of the upper and lower portions of the clamp die to force together said upper and lower portions of said clamp die through the machined portion so that the die pin annulus encompasses said catheter blank and forces said catheter blank against the die pin to minimize rotation of said catheter blank during the punching operation.

2. The clamp punch die assembly as recited in claim 1, wherein the clamp die includes a notched region through which the knife-edge punch die can traverse to remove the precision-notched portion of the catheter blank.

3. The clamp punch die assembly as recited in claim 2; wherein the notched region is structured and arranged so that, during removal of the precision-notched portion of the catheter blank, the knife-edge punch die does not contact the clamp die.

4. The clamp punch die assembly as recited in claim 2, wherein the notched region is structured and arranged so that the precision-notched portion of the catheter blank includes an approximately 90-degree angle at one end of the precision-notched portion and an approximately 50-degree angle at another end of said precision-notched portion.

5. The clamp punch die assembly as recited in claim 1, wherein the die pin includes a notched area through which the knife-edge punch die can traverse to remove the precision-notched portion of the catheter blank.

6. The clamp punch die assembly as recited in claim 5, wherein the notched area is structured and arranged so that, during removal of the precision-notched portion of the catheter blank, the knife-edge punch die does not contact the die pin.

7. The clamp punch die assembly as recited in claim 5, wherein the notched area is structured and arranged so that the precision-notched portion of the catheter blank includes an approximately 90-degree angle at one end of the precision-notched portion and an approximately 50-degree angle at another end of said precision-notched portion.

8. The clamp punch die assembly as recited in claim 1, wherein the clamp die includes a notched region and the die pin includes a notched area through which the knife-edge punch die can traverse to remove the precision-notched portion, wherein the notched region is in registration with the notched area.

9. The clamp punch die assembly as recited in claim 1, wherein the die pin includes a ground shoulder to arrest the catheter blank at a specific location.

10. The clamp punch die assembly as recited in claim 1, wherein the machined portion is a discontinuous opening that bisects the clamp die into its upper and lower portions.

11. A system for providing a precision-notched shape on a catheter blank having a periphery, the system comprising:
a clamp punch die assembly for retaining a catheter blank during a punching operation to provide a precision-notched portion in the catheter blank using a knife-edge punch die, to minimize rotation of said catheter blank; the clamp punch die assembly including:
a clamp die having an upper portion, a lower portion, a machined portion that separates the upper portion from the lower portion, and a die pin annulus, and
a die pin that is structured and arranged concentrically and coaxially within the die pin annulus and about which said catheter blank can be installed;
a clamping means for applying a force to at least one of the upper and lower portions of the clamp die, to force together said upper and lower portions of said clamp die through the machined portion so that the die pin annulus encompasses said catheter blank and forces said catheter blank against the die pin to minimize rotation of said catheter blank during the punching operation; and
a knife-edge punch die to remove said precision-notched area from said catheter blank.

12. The system as recited in claim 11, wherein the clamping means comprises a circular clamping means that, when engaged, provides an approximately 360-degree restraint against movement or rotation of the catheter blank during a punching operation.

13. The system as recited in claim 11, wherein the clamping means comprises one or more levers.

14. The system as recited in claim 11, wherein the clamping means includes using pressure created by a press punch.

15. The system as recited in claim 11, wherein the clamp die includes a notched region through which a punching tool can traverse to remove the precision-notched portion of the catheter blank.

16. The system as recited in claim 15, wherein the notched region is structured and arranged so that, during removal of the precision-notched portion of the catheter blank, the punching tool does not contact the clamp die.

17. The system as recited in claim 15, wherein the notched region is structured and arranged so that the precision-notched portion of the catheter blank includes an approximately 90-degree angle at one end of the precision-notched portion and an approximately 50-degree angle at another end of said precision-notched portion.

18. The system as recited in claim 11, wherein the die pin includes a notched area through which the punching tool can traverse to remove the precision-notched portion of the catheter blank.

19. The system as recited in claim 18, wherein the notched area is structured and arranged so that, during removal of the precision-notched portion of the catheter blank, the punching tool does not contact the die pin.

20. The system as recited in claim 17, wherein the notched area is structured and arranged so the that precision-notched portion of the catheter blank includes an approximately 90-degree angle at one end of the precision-notched portion and an approximately 50-degree angle at another end of said precision-notched portion.

21. The system as recited in claim 11, wherein the clamp die includes a notched region and the die pin includes a notched area through which the knife-edge punch die can traverse to remove the precision-notched portion, wherein the notched region is in registration with the notched area.

22. The system as recited in claim 11, wherein the system further includes a stroke-limiting device that arrests further advancement of the knife-edge punch die.

23. The system as recited in claim 22, wherein the stroke-limiting device is selected from a group consisting of high-tension springs, ball bushings, damping pots, and hydraulic cylinders.

24. The system as recited in claim 11, wherein the knife-edge punch die consists of two knife-edge pieces that each includes a finely honed knife-edge blade that are structured and arranged to provide a 50-degree angle portion at a distal end of the precision-notched portion and a 90-degree angle portion at a proximal end of the precision-notched portion.

25. The system as recited in claim 11, wherein the knife-edge punch die consists of a single knife-edge piece that includes a finely honed knife-edge blade having a blunt portion, wherein the knife-edge blade is structured and arranged to provide a 50-degree angle portion at a distal end of the precision-notched portion and the blunt portion of the knife-edge blade provides a 90-degree angle at a proximal end of the precision-notched portion.

26. The system as recited in claim 11, wherein the clamp punch die assembly is made of hardened tool steel.

27. The system as recited in claim 26, wherein the hardened tool steel has a Rockwell C hardness of between about 58 and about 62.

28. The system as recited in claim 11, wherein the knife-edge punch die is made of hardened tool steel.

29. The system as recited in claim 28, wherein the hardened tool steel has a Rockwell C hardness of between about 58 and about 62.

30. A method of providing a precision-notched portion in a catheter blank, the method comprising the steps of:
providing a clamp punch die assembly, wherein the clamp punch die assembly includes a clamp die, having an upper portion, a lower portion, a machined portion, a die pin annulus, and a die pin that is removably and securely disposed in the die pin annulus and about which the catheter blank can be installed;
providing a die punch assembly;
removably and securely attaching a distal end of the clamp punch die assembly in the die punch assembly;
removably and securely inserting a proximal end of the clamp punch die assembly in a clamp die rest assembly;
inserting the catheter blank in the die pin annulus of the clamp die about the die pin;
clamping said clamp punch die assembly so that the periphery of the die pin annulus forces said catheter blank against said die pin to minimize rotation of said catheter blank; and
punching the precision-notched portion in said catheter blank using a punching tool.

31. The method as recited in claim 30, wherein the catheter blank is inserted in the die pin annulus about the die pin until a distal end of said catheter blank is in registration with a ground shoulder disposed on said die pin.

32. The method as recited in claim 30, the method further comprising the step of structuring and arranging the clamp punch die assembly to provide a notched region through which the punching tool can traverse to remove the precision-notched portion of the catheter blank.

33. The method as recited in claim 32, wherein the notched region is structured and arranged so that, during the punching step, the punching tool does not contact the upper or lower portions of the clamp punch die assembly.

34. The method as recited in claim 30, the method further comprising the step of structuring and arranging the die pin to provide a notched area through which the punching tool can traverse to remove the precision-notched portion of the catheter blank.

35. The method as recited in claim 34, wherein the notched area is structured and arranged so that, during the punching step, the punching tool does not contact the die pin.

36. The method as recited in claim 30, wherein the step of clamping said clamp punch die assembly includes applying a clamping force to at least one of the upper and lower portions of the clamp punch die assembly to force together said upper and lower portions of said clamp punch die assembly through the machined portion so that the die pin annulus encompasses said catheter blank and forces said catheter blank against the die pin, to minimize rotation of said catheter blank during the punching step.

37. The method as recited in claim 30, wherein the step of punching the precision-notched portion of the catheter blank includes forming an approximately 90-degree angle at one end of the precision-notched portion and forming an approximately 50-degree angle at another end of said precision-notched portion.

38. The method as recited in claim 30, wherein the step of punching the precision-notched portion in the catheter blank includes using a knife-edge punch die as a punching tool.

39. The method as recited in claim 30, further comprising the step of removing any flashing produced during the punching step.

40. The method as recited in claim 30, further comprising the step of heat-flashing the precision-notched portion of the catheter blank to smooth the periphery of said precision-notched portion.

41. The method as recited in claim 40, wherein the step of heat-flashing the precision-notched portion of the catheter blank includes subjecting said precision-notched portion to a burst of hot air for a prescribed duration of time.

42. The method as recited in claim 41, wherein the step of heat-flashing the precision-notched portion of the catheter blank includes controlling how long said precision-notched portion is subject to the burst of hot air.

43. The method as recited in claim 40, wherein, during the step of heat-flashing, areas immediately adjacent to the precision-notched portion are masked so that only the precision-notched portion of the catheter blank is subject to the burst of hot air.

44. The method as recited in claim 41, wherein the burst of hot air has a temperature that is at or nearly at the melting point of the catheter blank.

45. The method as recited in claim 30 further comprising the step of tipping the catheter blank to close a distal end thereof.
